(19) United States
(12) Patent Application Publication
(10) Pub. No.: US 2008/0030989 A1
(43) Pub. Date: Feb. 7, 2008

(54) Backlight assembly and display apparatus having the same

(76) Inventors: Yong-Seok Yang, Chungcheongnam-do (KR); Jung-Tae Kang, Gyeonggi-do (KR); Jin-Ho Ha, Gyeonggi-do (KR); Yoon-Soo Kwon, Gyeonggi-do (KR)

Correspondence Address: MACPHERSON KWOK CHEN & HEID LLP, 2033 GATEWAY PLACE, SUITE 400, SAN JOSE, CA, 95110, US

(21) Appl. No.: 11/881,508

(22) Filed: Jul. 27, 2007

(30) Foreign Application Priority Data
Jul. 28, 2006 (KR) 10-2006-0071534

(51) Int. Cl. F21V 19/00; F21V 7/04

(52) U.S. Cl. 362/235; 362/249

(57) ABSTRACT

A backlight assembly includes a plurality of lamps, a power supply unit, a receiving container and an adhesive member. The power supply unit applies a driving voltage to a first electrode part of each of the lamps. The lamps are disposed parallel to the bottom plate of the receiving container. A ground part makes contact with a second electrode part of each of the lamps. The adhesion member secures the second electrode part to the ground part.

### CROSS-REFERENCE TO RELATED APPLICATIONS

This application claims priority to Korean Patent Application No. 10-2006-71534 filed on Jul. 28, 2006, the contents of which are herein incorporated by reference in their entirety.

### BACKGROUND OF THE INVENTION

1. Field of the Invention

The present invention relates to a backlight assembly and a display apparatus having the backlight assembly. More particularly, the present invention relates to a backlight assembly capable of reducing the number of lamp driving components and a display apparatus having the backlight assembly

2. Description of the Related Art

In general, a liquid crystal display (LCD) apparatus includes an LCD panel, a driver integrated circuit and a backlight assembly. Liquid crystal cells forming a pixel unit are arranged in the LCD panel as a matrix shape. The driver integrated circuit drives the liquid crystal cells. The backlight assembly supplies light uniformly to the LCD panel.

The backlight assembly is classified into a direct illumination type and an edge illumination type. A lamp as a light source of the direct illumination type backlight assembly is disposed on a rear surface of the LCD panel, and supplies light to the LCD panel. A light guide plate is disposed on the rear surface of the LCD panel, and a lamp of the edge illumination type backlight assembly is disposed on at least one side of the light guide plate and supplies light through the light guide plate to the LCD panel.

The direct illumination type backlight assembly has less uniformity of light and less durability than the edge illumination type. However, the direct illumination type backlight assembly includes a plurality of lamps arranged substantially in parallel to have a high brightness, so that the direct illumination type backlight assembly is generally used in a large-screen LCD device that requires high brightness.

In order to drive the lamps arranged substantially parallel, a conventional LCD device includes an inverter master, an inverter slave and a return wire. The inverter master applies a lamp driving voltage to a hot electrode of each of the lamps. The inverter slave electrically connects a cold electrode of the lamp to ground potential, and functions as a conductive pattern to transmit a feedback of an output current from the cold electrode to the inverter master. The return wire electrically connects the conductive pattern to the inverter master, and transmits a feedback of the current to the inverter master. The LCD device may further include an inverter having a circuit part reducing the deviation of the lamp driving voltage based on a feedback current as an input signal.

The inverter slave includes a printed circuit board (PCB), and is electrically grounded to a receiving container. Cold electrodes of a plurality of lamps are electrically grounded through the inverter slave to the receiving container.

However, each of the lamps cold electrodes is electrically connected to the inverter slave through a lamp socket and a connecter. The number of assembly processes of the backlight assembly is increased, and components such as a side mold and the container of the LCD device have a complex structure in order to receive the return wire. Thereby, efficiency of assembly process is deteriorated.

### SUMMARY OF THE INVENTION

An example embodiment of the present invention provides a backlight assembly having the decreased number of components for driving a plurality of lamps.

A further example embodiment of the present invention also provides a display apparatus having the above-mentioned backlight assembly.

In example embodiments of the present invention, a backlight assembly includes a plurality of lamps, a power supply unit, a receiving container and an adhesion member. Each of the lamps includes a first electrode part and a second electrode part. The receiving container includes a bottom plate, a sidewall and a ground part. The lamps are disposed substantially parallel at the bottom plate. The sidewall is extended from the bottom plate to form a receiving space. The ground part makes contact with the second electrode part of each of the lamps. The adhesion member fixes the second electrode part to the ground part.

In the example embodiment of the present invention, the adhesion member includes a conductive material. The backlight assembly may further include an additional conductive member disposed between the second electrode part and the ground part. The ground part includes a first surface and a second surface. The first surface is extended from the bottom plate to face the sidewall. The second surface is extended from the sidewall to face the bottom plate and connected to the first surface, and the adhesion member is attached to the second surface. The adhesion member includes an adhesive tape. The adhesion member includes a plate and an adhesive material covering at least one surface of the plate. The plate includes a groove corresponding to the second electrode.

The backlight assembly may further include a side cover. The side cover covers the second electrode part. The side cover includes protrusions to press the adhesion member corresponding to the second electrode part. The backlight assembly may further include a lamp support and a lamp socket. The lamp support fixes the lamps on the bottom plate. An end portion of the lamp including the first electrode part is inserted into the lamp socket, and the lamp socket electrically connects the first electrode part to the power supply unit. The backlight assembly may further include an optical sheet on the lamps.

In another example embodiment of the present invention, a backlight assembly includes a light guide unit, a light source, a receiving container and a power supply unit. The light source includes a lamp, a lamp reflector and an adhesion member. The lamp is disposed at a side of the light guide unit and has a first electrode part and a second electrode part. The lamp reflector surrounds the lamp and includes an opening in a direction facing the side of the light guide unit and includes a ground part contacted by the second electrode part. The adhesion member fixes the second electrode to the ground part. The receiving container includes a bottom plate at which the light guide unit and the light source are disposed and a sidewall extended from the bottom plate along the side of the light guide unit. The power supply unit is disposed on an outside of the receiving container to apply a driving voltage to the first electrode part.

The adhesion member includes a conductive material. The lamp reflector includes a first reflection part facing the side of the light guide unit, a second reflection part extended from the first reflection part substantially parallel with the bottom plate and a third reflection part facing the second reflection part. The ground part is protruded from at least one of the first, second and third reflection parts.

In still another example embodiment of the present invention, a display apparatus includes a backlight assembly, a first side cover, a second side cover, an optical sheet and a display panel. The backlight assembly includes a plurality of lamps having a first electrode part and a second electrode part. The power supply unit applies a driving voltage to the first electrode part of each of the lamps. A plurality of the lamps is disposed at the bottom plate. The sidewall is extended from the bottom plate to form a receiving space. The receiving container includes a ground part making contact with the second electrode part of each of the lamps. The adhesion member fixes the second electrode part to the ground part. The first side cover covers a first end portion of the lamp including the first electrode part. The second side cover covers a second end portion of the lamp including the first electrode part, and protrusions pressing the adhesion member corresponding to the second electrode part are formed on the second side cover. The optical sheet and the display panel are disposed on the first side cover and the second side cover, in sequence. The adhesion member includes a conductive material.

According to the backlight assembly and the display substrate, the second electrode part of the lamp electrically connected to a ground potential has a simple structure so that the number of components of the backlight assembly and the display apparatus is reduced, and an assembly process is simplified.

### BRIEF DESCRIPTION OF THE DRAWINGS

The above and other advantages of the present invention will become readily apparent by reference to the following detailed description when considered in conjunction with the accompanying drawings, wherein:

FIG. 1 is an exploded perspective view illustrating a backlight assembly in accordance with an embodiment of the present invention;

FIG. 2 is a plan view illustrating the backlight assembly illustrated in FIG. 1;

FIG. 3 is an enlarged plan view illustrating a portion of the backlight assembly illustrated in FIG. 2;

FIG. 4 is a perspective view illustrating a rear surface of the backlight assembly illustrated in FIG. 2;

FIG. 5 is a perspective view illustrating a rear surface of the side cover illustrated in FIG. 1;

FIG. 6 is a cross-sectional view taken along a line I-I′ of FIG. 1;

FIG. 7 is a cross-sectional view taken along a line II-II′ of FIG. 1;

FIG. 8 is a cross-sectional view illustrating a backlight assembly in accordance with another embodiment of the present invention;

FIG. 9 is an exploded perspective view illustrating a backlight assembly in accordance with another embodiment of the present invention;

FIG. 10 is a perspective view illustrating the light source illustrated in FIG. 9;

FIG. 11 is a cross-sectional view taken along a line III-III′ of FIG. 9;

FIG. 12 is a cross-sectional view taken along a line IV-IV′ of FIG. 9;

FIG. 13 is an exploded perspective view illustrating a display apparatus in accordance with another embodiment; and

FIG. 14 is a cross-sectional view taken along a line V-V′ of FIG. 13.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

Backlight Assembly

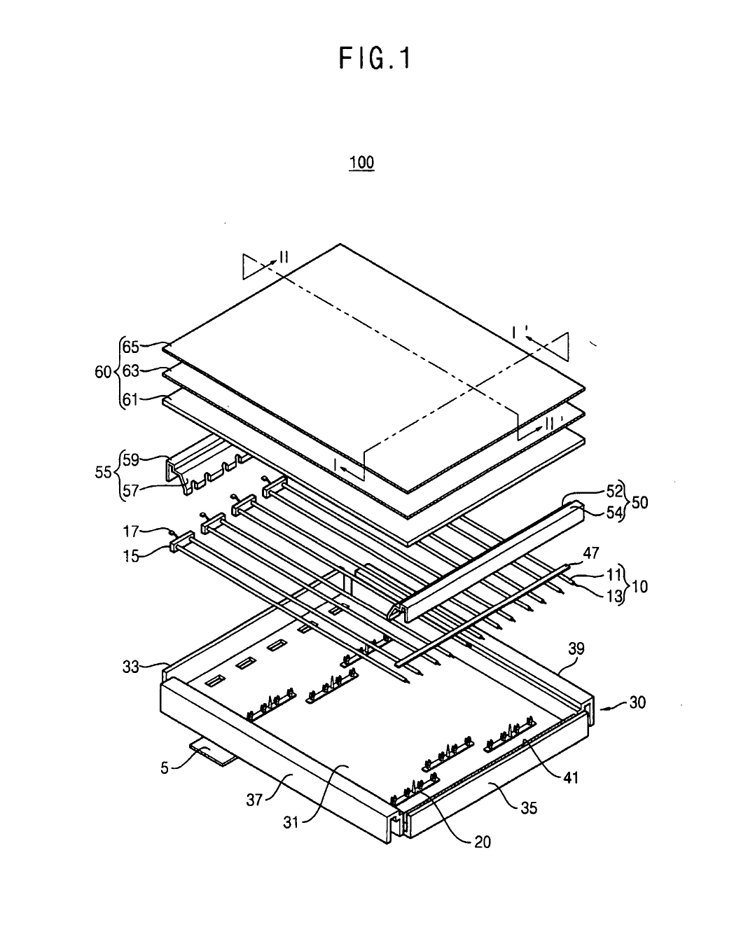

FIG. 1 is an exploded perspective view illustrating a backlight assembly in accordance with an embodiment of the present invention.

Referring to FIG. 1, a backlight assembly 100 includes a plurality of lamps 10, a power supply unit 5, a receiving container 30 and a conductive adhesion member 47.

A plurality of the lamps 10 is electrically connected to each other, in parallel. In FIG. 1, the lamps 10 may be cold cathode fluorescent lamps (CCFL). Each of the lamps 10 includes a lamp body 11, a first electrode part (not shown) and a second electrode part 13.

The lamp body 11 includes a linear tube. A discharge gas such as argon and mercury is injected into the lamp body 11, and a fluorescent material is coated to an inner surface of the lamp body 11. The first electrode part and the second electrode part 13 are disposed at both end portions of the lamp body 11 to face each other. The first electrode part includes a discharge electrode and a lead line. The discharge electrode is disposed inside of the lamp body 11, and the lead line is extended from the discharge electrode to an outside of the lamp body 11. The second electrode part 13 also includes a discharge electrode and a lead line. Hereinafter, the second electrode part 13 will be referred to indicate ‘the lead line’ of the second electrode part 13.

In another embodiment, the lamps 10 may include an external electrode fluorescent lamp (EEFL). The external electrode fluorescent lamp has various characteristics such as a high-brightness, low-cost and low- power consumption, and a plurality of external electrode fluorescent lamps may be driven by one power supply unit.

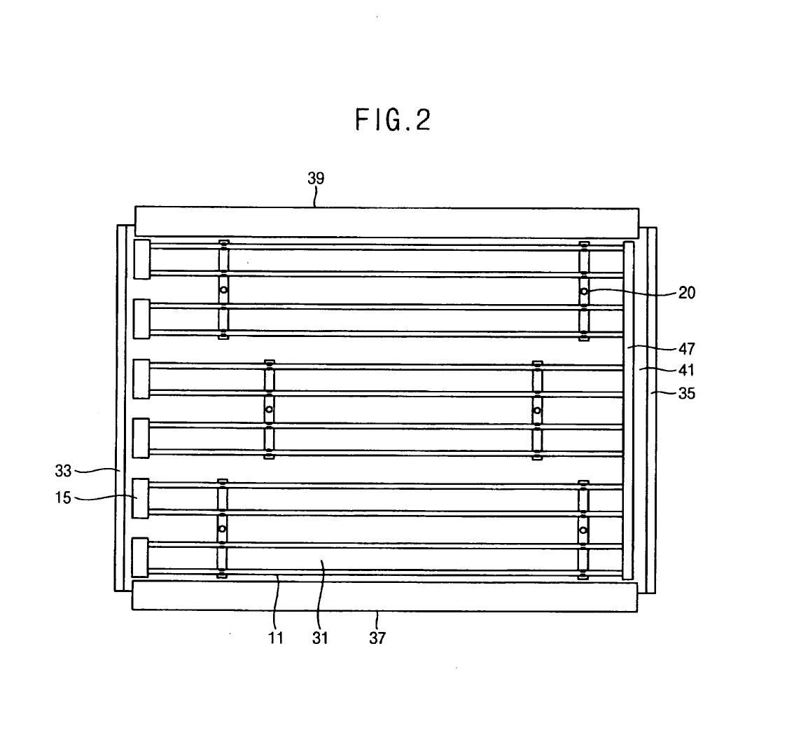

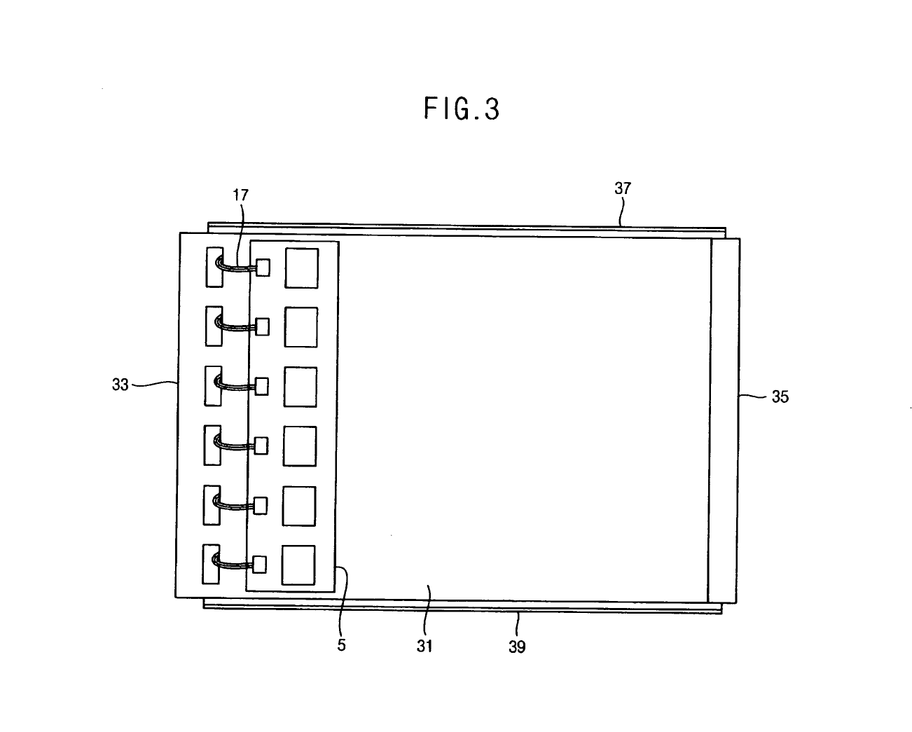

FIG. 2 is a plan view illustrating the backlight assembly illustrated in FIG. 1. FIG. 3 is an enlarged perspective view illustrating a portion of the backlight assembly illustrated in FIG. 2.

Referring to FIGS. 1 to 4, the receiving container 30 receives a plurality of the lamps 10. The receiving container 30 includes a bottom plate 31, a first sidewall 33, a second sidewall 35, a third sidewall 37, a fourth sidewall 39 and a ground part 41.

The bottom plate 31 has a substantial rectangular shape. The first sidewall 33, the second sidewall 35, the third sidewall 37 and the fourth sidewall 39 are extended from a peripheral area of the bottom plate 31 to form a receiving space. The first sidewall 33 and the second sidewall 35 face each other. The third sidewall 37 and the fourth sidewall 39 face each other to connect the first sidewall 33 and the second sidewall 35, respectively. Stepped portions are formed on upper portions of the third sidewall 37 and the fourth sidewall 39. A plurality of openings is formed at the bottom plate 31 along the first sidewall 33 adjacent to the first sidewall 33.

The ground part 41 is extended from the bottom plate 31 of the receiving container 30 on the second sidewall 35. The ground part 41 of the present embodiment includes a stepped portion formed at the second sidewall 35. An edge formed by the bottom plate 31 and the second sidewall 35 is bent, thereby forming the ground part 41. The ground part 41 includes a first surface 42 and a second surface 44. The first surface 42 is extended from the bottom plate 31 to face the second sidewall 35. The second surface 44 is extended from the second sidewall 35 to face the bottom plate 31, and is connected to the first surface 42. A height between the bottom plate 31 and the second surface 44 may be substantially the same as a height between the bottom plate 31 and the second electrode part 13.

The backlight assembly 100 may further include a plurality of lamp supporters 20. The lamp supporters 20 are fixed to the bottom plate 31. The lamp supporters 20 align the lamps 10 substantially parallel with each other, and prevent the lamps 10 from sagging. A portion of the lamp supporters 20 are disposed between a center part and the first electrode part of each of the lamps 10, and a remaining portion of the lamp supporters 20 are adjacent to the second electrode part 13 of each of the lamps 10.

The lamp supporter 20 includes a fixing plate and a plurality of fixing ring parts. The fixing plate is disposed in a direction that is substantially in perpendicular to a longitudinal direction of the lamps 10 of the bottom plate 31. The fixing ring parts are formed as a ring shape, and an upper portion of the ring shape is opened. The fixing ring parts are formed on the fixing plate at a constant interval. Second end portions of the lamps 10 having the second electrode part 13 face the first surface 42 of the ground part 41, and the second electrode parts 13 make contact with the second surface 44.

The conductive adhesion member 47 adheres to the second surface 44 of the ground part 41. The conductive adhesion member 47 may include a conductive material. The conductive adhesion member 47 may further includes an additional conductive adhesion member disposed between the second electrode part and the ground part. The conductive adhesion member 47 such as a conductive adhesive tape fixes the second electrode parts 13 to the second surface 44 of the ground part 41, thereby improving a reliability of an electric connection between the second electrode parts 13 and the ground part 41.

The conductive adhesion member 47 includes a plate coated by adhesive material. The plate includes a groove corresponding to the second electrode.

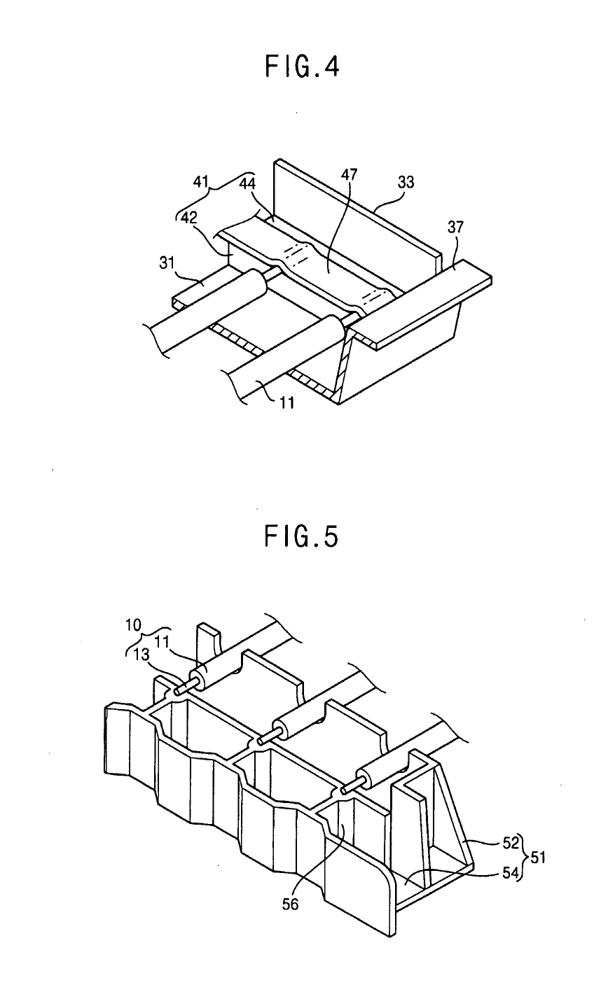

FIG. 4 is a perspective view illustrating a rear surface of the backlight assembly illustrated in FIG. 2.

Referring to FIGS. 1 to 4, the backlight assembly 100 may further include a lamp socket 15.

The lamp socket 15 receives a first end portion of each of the lamps 10 having the first electrode part. For example, two lamps 10 are combined with one lamp socket 15. The lamp socket 15 is fixed to the bottom plate 31 adjacent to the first sidewall 33, and a connecter 17 electrically connected to the lamp socket 15 is extended toward and outside of a rear surface of the bottom plate 31 through an opening.

The power supply unit 5 is disposed on the rear surface of the bottom plate 31. The power supply unit 5 supplies a driving voltage to the lamps 10. The connecter 17 passing through the opening is electrically connected to a terminal of the power supply unit 5. The power supply unit 5 applies a driving voltage to the first electrode part.

Thereby, an electric field is formed between the first electrode part and the second electrode part 13, and an arc discharge is generated from the first electrode part. A discharge gas emits an ultraviolet light by the arc discharge. The ultraviolet light passes through a fluorescent material, and is changed into a visible light.

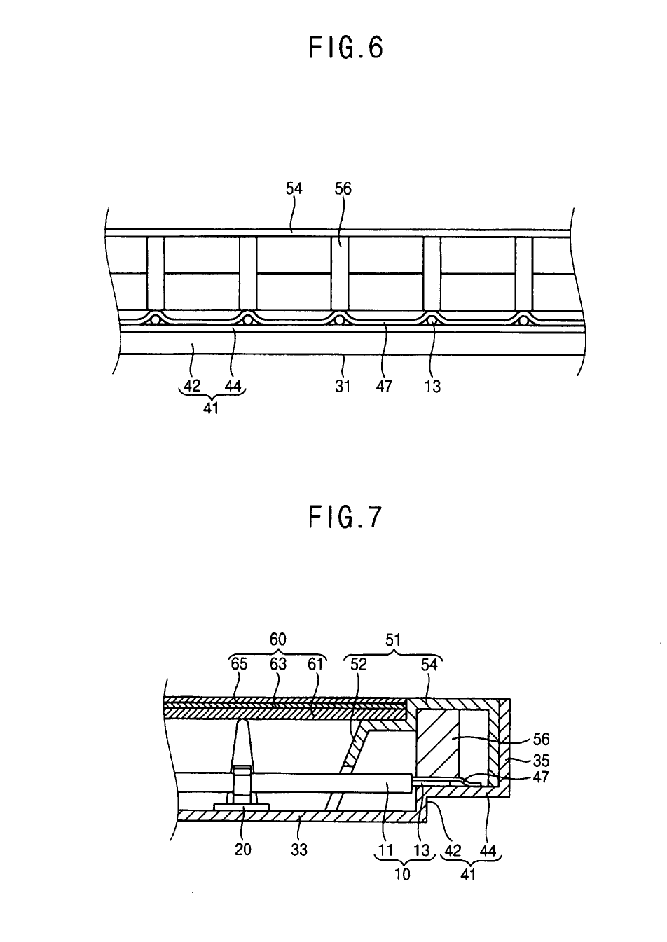

FIG. 5 is a perspective view illustrating a rear surface of the side cover illustrated in FIG. 1. FIG. 6 is a cross-sectional view taken along a line I-I′ of FIG. 1. FIG. 7 is a cross-sectional view taken along a line 11-II′ of FIG. 1.

Referring to FIGS. 1, 5, 6 and 7, the backlight assembly 100 may further include a first side cover 55, a second side cover 50 and an optical sheet 60.

The first side cover 55 is disposed along the first sidewall 33, and covers a first end portion of the lamps 10. The first side cover 55 includes a supporting plate 57 and an upper plate 59. The supporting plate 57 faces the first sidewall 33, and makes contact with the bottom plate 31. Guiding grooves are formed at the supporting plate 57 to guide the lamps 10. The upper plate 59 is extended from the supporting plate 57 to face the bottom plate 31. A stepped portion is formed at the upper plate 59 to support the optical sheet 60.

The second side cover 50 is disposed along the second sidewall 35 to cover the second end portion of the lamps 10. The second side cover 50 includes a supporting plate 52 and an upper plate 54. Protrusions 56 are formed at the upper plate 54 of the second side cover 50. The protrusions 56, as illustrated in FIG. 5, are formed at a rear surface of the upper plate 54 of the second side cover 50. Each of the protrusions 56 corresponds to each of the second electrode part 13 disposed at the ground part 41, as illustrated in FIGS. 6 and 7. Each of the protrusions 56 presses the conductive adhesive tape 47. Thereby, reliability of an electric connection between the second electrode parts 13 and the ground part 41 is improved.

In FIGS. 1 and 5, the second end portion of the lamp 10 is not fixed by the lamp socket 15 that fixes the first end portion of the lamp 10 to the receiving container 30. An adhesive strength of the conductive adhesive tape 47 fixing the second electrode part 13 to the ground part 41 may be smaller than an adhesive strength between the lamp socket 15 and the receiving container 30. Therefore, the lamp supporter 20 may be adjacent to the second electrode part 13 so that the adhesive strength between the second end portion of the lamp 10 and the ground part 41, thereby preventing separation of the second end portion of the lamp 10 by an externally provided impact.

The optical sheet 60 improves optical characteristics of light generated from the lamps 10. The optical characteristics include brightness, uniformity and front brightness. The optical sheet 60 includes a diffusion plate 61 and light condensing sheets 63 and 65. The diffusion plate 61 and the light condensing sheets 63 and 65 are disposed on the stepped portion formed on the first side cover 55 and the second side cover 50. The diffusion plate 61 improves brightness uniformity of the light from the lamps 10, and the light condensing sheets 63 and 65 improves front brightness of light having passed through the diffusion plate 61. The optical sheet 60 may further include a diffusion sheet disposed between the diffusion plate 61 and the light condensing sheets 63 and 65, and a reflection sheet disposed on the bottom plate 31.

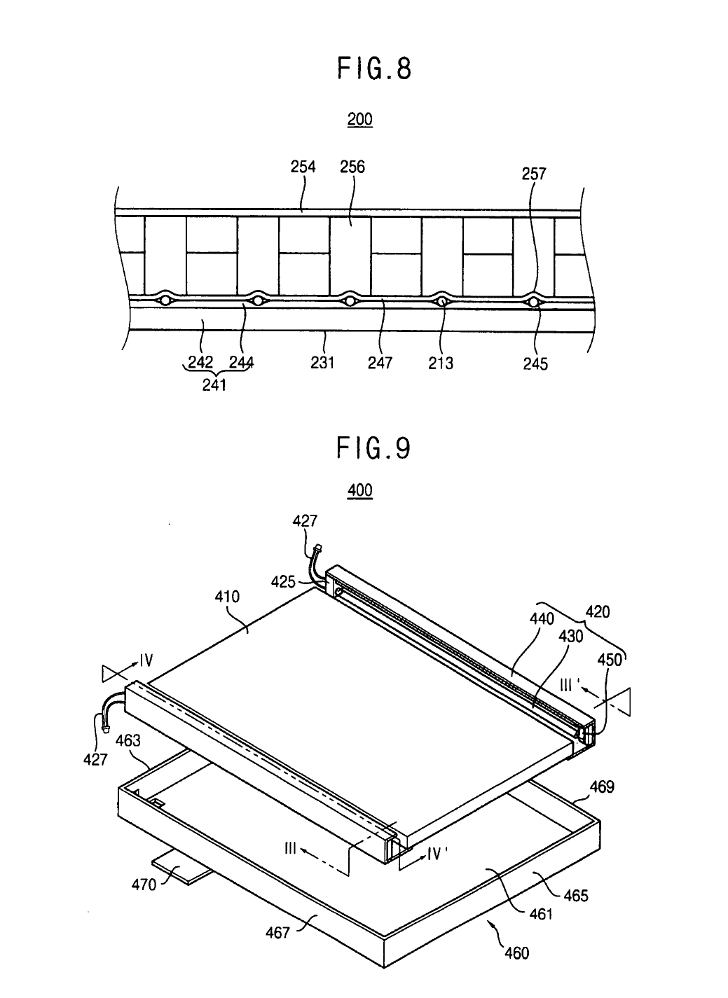

FIG. 8 is a cross-sectional view illustrating a backlight assembly in accordance with another embodiment of the present invention.

Referring to FIG. 8, a backlight assembly 200 includes a plurality of lamps, a power supply unit, a receiving container, a conductive adhesion member 247, a lamp supporter, a lamp socket, a first side cover, a second side cover and an optical sheet. The backlight assembly 200 of FIG. 8 is substantially the same as the backlight assembly 100 of FIGS. 1 to 7 except a shape of a ground part 241 formed at the receiving container and a shape of a protrusion part 256 formed at the second side cover.

The ground part 241 includes a first surface 242 and a second surface 244, and is substantially the same as the ground part 41 illustrated in FIGS. 1, 2, 4, 6 and 7 except supporting grooves 245 formed on the second surface 244. A second electrode part 213 of each of the lamps 10 is disposed on each of the supporting grooves 245.

The lamps are aligned to predetermined positions on a bottom plate 231 of the receiving container by the lamp supporters. The second electrode part 213 is partially received on the supporting groove 245 to prevent a horizontal movement of the second electrode part 213. The conductive adhesive member 247 is attached to the second surface 244 of the ground part, and an upper portion of the second electrode part 213 that is received in the supporting groove 245 and is protruded from the supporting groove 245. A depth of the supporting groove 245 may be smaller than a diameter of the second electrode part 213 so that the conductive adhesive tape is attached to the upper portion of the second electrode part 213.

A second side covers a second end portion of the lamp having the second electrode part 213 and includes a supporting plate having guide grooves, which prevents interference with the lamp body, and an upper plate 254 facing the bottom plate 231 connected to the supporting plate.

The protrusion parts 256 are formed at a rear surface of the upper plate 254 corresponding to each of the second electrode parts 213. The protrusion parts 256 press the conductive adhesion member 247. Moreover, a fixing groove 257 receiving the second electrode part 213 is formed at end portions of the protrusion parts 256. A depth of the fixing groove 257 may be smaller than a diameter of the second electrode part 213.

When the supporting groove 245 and the fixing groove 257 face each other, a receiving space corresponding to a shape of the second electrode part 213 is formed. A height of the receiving space may be smaller than a diameter of the second electrode part 213, so that the ground part 241 and the protrusion part 256 may press the second electrode part 213.

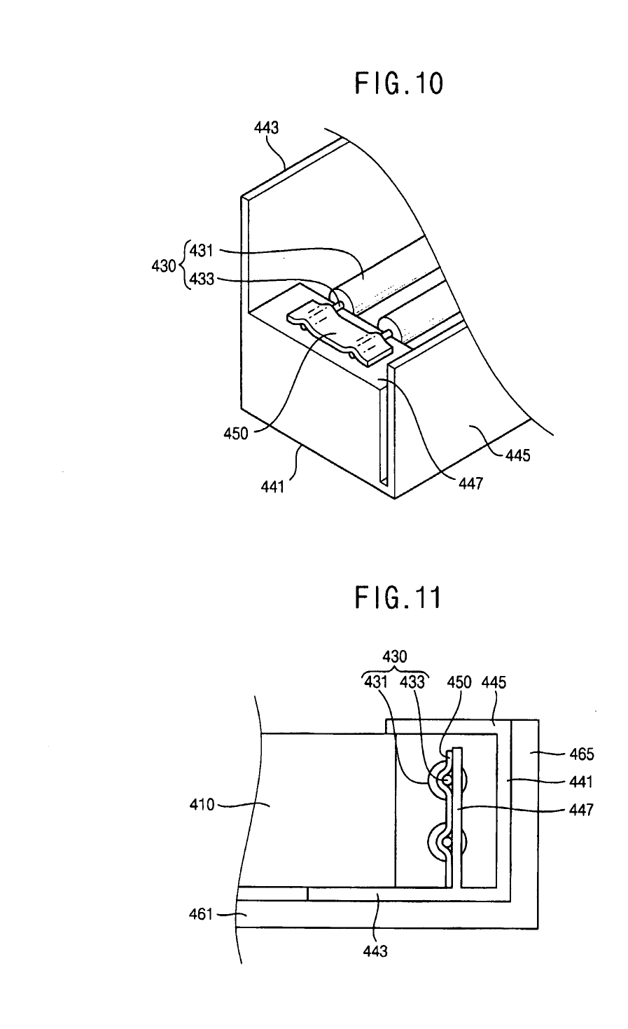

FIG. 9 is an exploded perspective view illustrating a backlight assembly in accordance with another embodiment of the present invention. FIG. 10 is a perspective view illustrating the light source illustrated in FIG. 9.

Referring to FIGS. 9 and 10, a backlight assembly 400 includes a light guide unit 410, a light source 420, a receiving container 460, and a power supply unit 470.

The light guide unit 410 has a substantially plate shape, and guides incident light to emit surface light. The light guide unit 410 may include an optical material having various characteristics such as excellent light transmissivity, thermal endurance, chemical resistance and mechanical rigidity. Examples of the optical material that can be used for the light guide unit 410 include polymethylmethacrylate (PMMA), and polycarbonate (PC).

The light source 420 emits light so that the light generated from the light source 420 is incident into the light guide unit 410 through a side surface of the light guide unit 410. The light source 420 is disposed at the side surface of the light guide unit 410, or is disposed at opposite side surfaces of the light guide unit 410. The light source 420 includes a lamp 430, a lamp reflector 440 and a conductive adhesion member 450. The light source may include a plurality of lamps 430. The lamps 430 shown in FIGS. 9 and 10 are substantially the same as the lamps 10 of FIG. 1.

The lamp reflector 440 surrounds the lamps 430, and is open in a direction toward a side of the light guide unit 410. The lamp reflector 440 includes a ground part 447 electrically connected to the second electrode part 433 of the lamp 430.

The lamp reflector 440, for example, may include a first reflection part 441, a second reflection part 443 and a third reflection part 445. The first reflection part 441 faces the side of the light guide unit 410. The second reflection part 443 and the third reflection part 445 are extended from the first reflection part 441 to face each other, and are disposed substantially parallel with a light exiting surface of the light guide unit 410 of an opposite surface that is opposite to the light exiting surface.

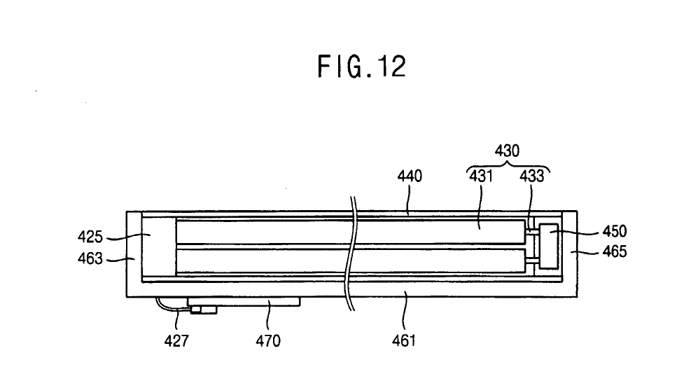

FIG. 11 is a cross-sectional view taken along a line III-III′ of FIG. 9. FIG. 12 is a cross-sectional view taken along a line IV-IV′ of FIG. 9.

Referring to FIGS. 11 and 12, the ground part 447 protrudes from at least one of the first reflection part 441, the second reflection part 443 and the third reflection part 445. The ground part 447 of FIG. 11 protrudes from the second reflection part 443, and includes a ground surface facing the first reflection part 441. The conductive adhesion member 450 is attached to the ground surface, and fixes the second electrode part 433 to the ground surface.

For example, a portion of a surface connected to the first, second and third reflection parts 441, 443 and 445 may be bent toward an inside of the lamp reflector 440 to form the ground part 447.

In another embodiment, the lamp reflector 440 may include a plurality of clip parts. The second electrode part 433 may be inserted into the clip parts, and may make contact with the clip parts. The clip parts, for example, may be formed integrally with the lamp reflector 440 by a sheet metal process to have a ring shape. A side of the ring shape may be opened through the sheet metal process. A position and a shape of the clip parts may be changed.

In still another embodiment, the lamp reflector 440 may further include a fourth reflection part. The fourth reflection part is disposed at a longitudinal end portion of the lamp reflector 440, and is connected to the first reflection part 441, the second reflection part 443 and the third reflection part 445. A contact hole into which the second electrode part 433 is inserted may be formed at the fourth reflection part.

The light source 420 may further include a lamp socket 425. The lamp socket 425 is inserted into an end portion of the lamp reflector 440, and is fixed to the end portion of the lamp reflector 440. A first end portion of the lamp 430 is inserted into the lamp socket 425. The lamp socket 425 electrically connects the first electrode part to the power supply unit 470.

The receiving container 460 includes a bottom plate 461, a first sidewall 463, a second sidewall 465, a third sidewall 467 and a fourth sidewall 469. The first sidewall 463 and the second sidewall 465 face each other. The third sidewall 467 and the fourth sidewall 469 face each other, and are connected to the first sidewall 463 and the second sidewall 465, respectively.

The receiving container 460 receives the light guide unit 410 and the light source 420. The light source 420 is disposed between a side surface of the light guide unit 410 and the third sidewall 467 of the receiving container 460 and between an opposite side surface to the side surface of the light guide unit 410 and the fourth sidewall 469 of the receiving container 460. The lamp socket 425 faces the first sidewall 463 of the receiving container 460. An opening through which a connecter 427 is electrically connected to the lamp socket 425 is formed at a rear surface of the bottom plate 461 corresponding to the lamp socket 425. The lamp reflector 440 makes contact with the receiving container 460, and is electrically connected to a ground potential through the receiving container 460.

In FIGS. 11 and 12, the second electrode part 433 of the lamp 430 directly makes electrical contact with the lamp reflector 440 without any extra connecting component such as the lamp socket 425 so that the second electrode part 433 is electrically connected to the ground potential through the receiving container 460.

The power supply unit 470 is disposed at the rear surface of the bottom plate 461, and is electrically connected to the lamp socket 425 through the connecter 427.

Therefore, when only one side of the lamp 430 is driven, any extra lamp socket 425 or a wire that is used for grounding the second electrode part 433 of the lamp 430 may be omitted.

Display Apparatus

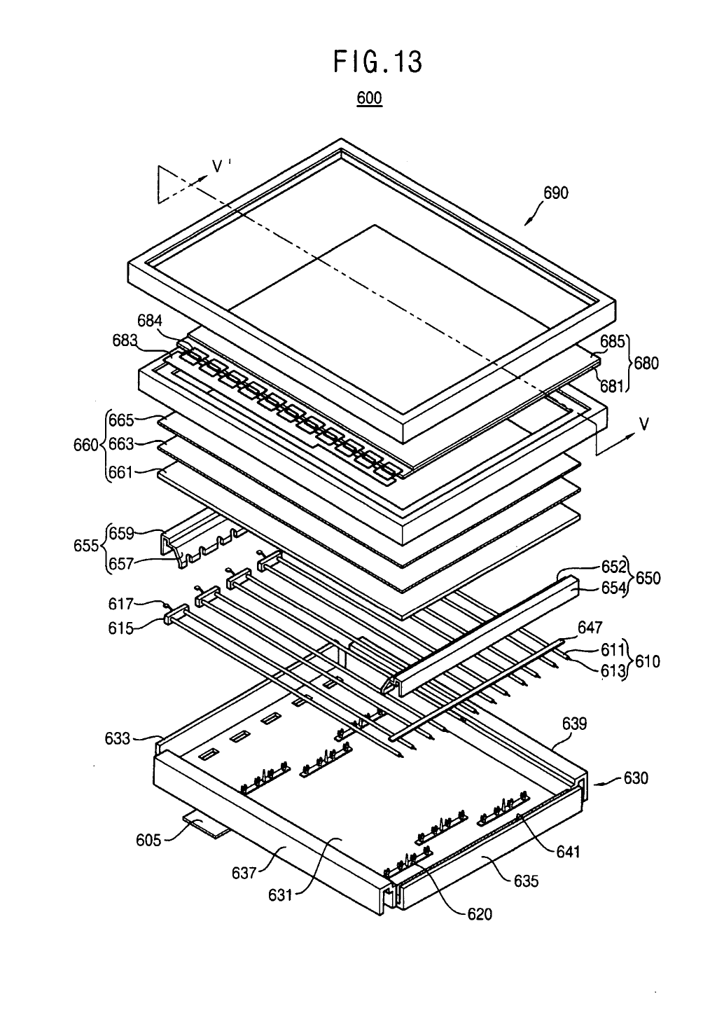

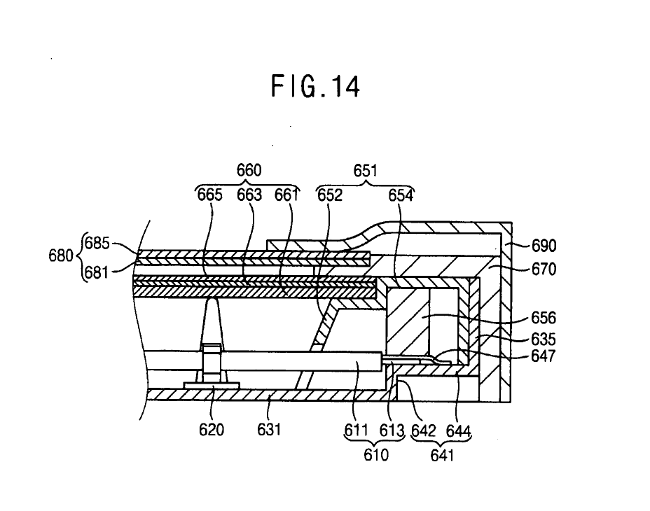

FIG. 13 is an exploded perspective view illustrating a display apparatus in accordance with another embodiment. FIG. 14 is a cross-sectional view taken along a line V-V′ of FIG. 13.

Referring to FIGS. 13 and 14, a display apparatus 600 includes a light emitting module, a first side cover 655, a second side cover 650, an optical sheet 660 and a display panel 680.

The light emitting module of FIGS. 13 and 14 is substantially similar to the backlight assembly 100 illustrated in FIGS. 1 to 7. Therefore, the light emitting module includes a plurality of lamps 610, a receiving container 630 having a ground part 641, a conductive adhesion member 647, a plurality of lamp supporters 620, a plurality of lamp sockets 615 and a power supply unit 605.

The first side cover 655, the second side cover 650 and the optical sheet 660 of FIGS. 13 and 14 are substantially the same as the first side cover 55, the second side cover 50 and the optical sheet 60 illustrated in FIG. 1.

The display apparatus 600 may further include a middle mold 670.

The middle mold 670 presses edges of light condensing sheets 663 and 665, and is combined with the receiving container 630. A panel guiding groove is formed on an upper surface of the middle mold 670.

The display panel 680 is disposed at the panel guiding groove and receives light from the optical sheet 660, and changes the light from the optical sheet 660 to a display image containing image information. The display panel 680 includes a thin film transistor substrate 681, a color filter substrate 685 facing the thin film transistor substrate 681 and a liquid crystal disposed between the thin film transistor substrate 681 and the color filter substrate 685.

The display panel 680 may further include a printed circuit board 683 and a panel printed circuit film 684. The printed circuit board 683 outputs a panel driving signal such as a gate voltage and a data voltage. An edge of the panel printed circuit film 684 is electrically connected to the display panel 680, and an opposite edge of the panel printed circuit film 684 is electrically connected to the printed circuit board 683. An arrangement of liquid crystals is changed according to the panel driving signal applied to the printed circuit board 683, thereby changing transmittance of light provided to the display panel. Thus, the display panel 680 may display the image having a predetermined gray-scale.

The display apparatus 600 may further include a top chassis 690. The top chassis 690 may include an opened portion that exposes an efficient display area of the display panel. The top chassis 690 is combined with the receiving container 630.

According to the backlight assembly including a plurality of lamps electrically connected to each other, substantially parallel, components such as a lamp socket for electrically grounding the second electrode parts of the lamps, the printed circuit board (or the inverter slave), a connecter electrically connecting the second electrode parts and the printed circuit board and a return wire sending a feedback of an electric current of a printed circuit board from the second electrode part to a power supply unit (or an inverter master) may be omitted. Thereby, the number of the components of the backlight assembly is reduced.

Moreover, the second electrode part of the lamp is directly and is electrically connected to the ground part, and a reliability of an electric connection between the second electrode part and the ground part is improved. Thereby, an assembly process of the lamp of a backlight assembly is simplified, and the assembly process of the backlight assembly and a display apparatus having the backlight assembly is also simplified.

It will of course be appreciated that many modifications, substitutions and variations can be made in and to the materials, apparatus, configurations and methods of the display panels of the present invention without departing from its spirit and scope. In light of this, the scope of the present invention should not be limited to that of the particular embodiments illustrated and described herein, as they are only exemplary in nature, but instead, should be fully commensurate with that of the claims appended hereafter and their functional equivalents.

What is claimed is:

1. A backlight assembly comprising:
a plurality of lamps, each of the lamps including a first electrode part and a second electrode part;
a receiving container including;
a bottom plate;
a sidewall extending from the bottom plate to form a receiving space for the lamps; and
a ground part making contact with the second electrode part of each of the lamps; and
an adhesive member contacting the second electrode part and the ground part.

2. The backlight assembly of claim 1, wherein the adhesive member comprises a conductive material.

3. The backlight assembly of claim 1, further comprising an additional conductive adhesive member disposed between the second electrode part and the ground part.

4. The backlight assembly of claim 1, wherein the ground part comprises:
a first surface extending from the bottom plate; and
a second surface extending from the first surface to the sidewall to face the bottom plate, wherein the adhesive member is attached to the second surface.

5. The backlight assembly of claim 4, wherein the second surface includes a plurality of supporting grooves, and further wherein the second electrode parts are positioned in the supporting grooves.

6. The backlight assembly of claim 4, wherein the adhesive member comprises an adhesive tape.

7. The backlight assembly of claim 4, wherein the adhesive member comprises a plate and an adhesive material covering at least one surface of the plate.

8. The backlight assembly of claim 7, wherein the plate comprises a groove corresponding to the second electrode.

9. The backlight assembly of claim 4, further comprising a side cover that covers the second electrode part, wherein the side cover includes a protrusion to press the adhesive member against the second electrode part.

10. The backlight assembly of claim 9, wherein the side cover comprises:
a supporting plate having guiding grooves that guide the lamps; and
an upper plate extending from the supporting plate to face the bottom plate, the upper plate having protrusions formed at a rear surface of the upper plate.

11. The backlight assembly of claim 9, wherein a fixing groove is formed at an end portion of each of the protrusions to receive the second electrode part.

12. The backlight assembly of claim 1, further comprising a lamp supporter including:
a fixing plate fixed at the bottom plate adjacent to the second electrode part; and
a plurality of fixing ring parts formed at the fixing plate, each of the fixing ring parts having a ring-shape including an opened side to receive each of the lamps.

13. The backlight assembly of claim 1, further comprising:
a power supply unit; and
a lamp socket electrically connecting the first electrode part to the power supply unit, wherein an end portion of the lamp including the first electrode part is inserted into the lamp socket.

14. The backlight assembly of claim 1, further comprising an optical sheet on the lamps.

15. A backlight assembly comprising:
a light guide unit;
a light source including;
a lamp having a first electrode part and a second electrode part, the lamp being disposed at a side of the light guide unit;
a lamp reflector surrounding the lamp to be opened in a direction facing the side of the light guide unit, the lamp reflector having a ground part electrically contacting to the second electrode part; and
an adhesion member fixing the second electrode to the ground part;
a receiving container including:
a bottom plate; and
a sidewall extending from the bottom plate along the side of the light guide unit; and
a power supply unit disposed on an outside of the receiving container to apply a driving voltage to the first electrode part.

16. The backlight assembly of claim 15, wherein the adhesive member comprises a conductive material.

17. The backlight assembly of claim 15, wherein the lamp reflector comprises:
a first reflection part facing the side of the light guide unit;
a second reflection part extended from the first reflection part substantially parallel with the bottom plate; and
a third reflection part facing the second reflection part, and
wherein the ground part is protruded from at least one of the first, second and third reflection parts.

18. The backlight assembly of claim 17, wherein the ground part faces the first reflection part, and comprises a ground surface to which the adhesion member adheres.

19. A display apparatus comprising:
a light emitting module including;
a plurality of lamps, each of the lamps having a first electrode part and a second electrode part;
a power supply unit applying a driving voltage to the first electrode part of each of the lamps;
a bottom plate at which a plurality of the lamps is disposed;
a sidewall extended from the bottom plate to form a receiving space;
a receiving container having a ground part making contact with the second electrode part of each of the lamps; and
an adhesion member fixing the second electrode part to the ground part;
a first side cover covering a first end portion of at least one of the lamps including the first electrode part;
a second side cover covering a second end portion of at least one of the lamps including the second electrode part, the second side cover including a plurality of protrusions pressing the conductive adhesion member corresponding to the second electrode part;
an optical sheet disposed on the first side cover and the second side cover; and
a display panel disposed on the optical sheet.

20. The display apparatus of claim 19, wherein the adhesion member comprises a conductive material.
